(19) United States
(12) Patent Application Publication
(10) Pub. No.: US 2010/0038298 A1
(43) Pub. Date: Feb. 18, 2010

(54) HIGH-PERFORMANCE CHROMATOGRAPHIC COLUMNS CONTAINING ORGANIC OR COMPOSITE POLYMERIC MONOLITHIC SUPPORTS AND METHOD FOR THEIR PREPARATION

(75) Inventors: Giancarlo Angelini, Rome (IT); Ornella Ursini, Rome (IT); Francesco Gasparrini, Rome (IT); Claudio Villani, Rome (IT)

Correspondence Address: LUCAS & MERCANTI, LLP, 475 PARK AVENUE SOUTH, 15TH FLOOR, NEW YORK, NY, 10016, US

(73) Assignees: CONSIGLIO NAZIONALE DELLE RICERCHE, Rome (IT); UNIVERSITA' DEGLI STUDI DI ROMA 'LA SAPIENZA', Rome (IT); AVANTECH GROUP S.R.L., Angri (SA) (IT)

(21) Appl. No.: 12/520,110

(22) PCT Filed: Dec. 21, 2007
(86) PCT No.: PCT/IT2007/000907

§ 371 Date: Jun. 30, 2009

(30) Foreign Application Priority Data
Dec. 29, 2006 (IT) RM2006A000723

(51) Int. Cl. B01J 20/289; B01J 20/286; B01J 20/30

(52) U.S. Cl. 210/198.2; 264/447

(57) ABSTRACT

The invention concerns high-performance chromatographic columns containing polymeric monolithic supports with continuous bimodal porosity, suitable for the separation and/or purification of organic compounds of low, medium and high molecular weight, and bio-organic compounds such as peptides, proteins, oligo- and polynucleotides, oligo- and polysaccharides. The proposed columns include a hollow tubular support made of silica-based amorphous material or internally lined with such material, containing a monolithic stationary phase having a continuous, porous and rigid polymeric structure, wherein such stationary phase covalently bonds onto the internal walls of the said hollow tubular support. The chromatographic efficiency of the column is greater than 50,000 plates per metre. The invention also concerns methods for preparing such monolithic columns with gamma radiation-induced polymerization processes.

The present invention concerns high-performance chromatographic columns containing organic or composite—i.e. with inorganic components—polymeric monolithic supports, and the relative method for their preparation. More specifically, the invention concerns new high-performance chromatographic columns containing, as stationary phase, monolithic polymeric materials with bimodal continuous porosity, that is, with diffusive pores, of smaller size, and convective pores, or larger size, suitable for the separation and/or purification of organic and bio-organic compounds of any kind, obtained via in-situ polymerization processes induced by gamma radiation, in monolithic form and directly anchored to the appropriately pre-treated inside wall of the capillary or column.

Recent research activities linked to the discovery and development of target molecules with therapeutic properties call for high-efficiency, high resolution and sensitivity screening technologies. The demand for these technologies is very important in those research fields where the factor limiting the overall speed of the whole research project is represented by the rate at which individual components of complex mixtures can be isolated and identified. This situation is increasingly more frequent in biomedical research such as in the analysis of libraries of molecules of low molecular weight coming from combinatorial synthesis, the biotechnological production of target molecules, proteomics and metabolomics. Of the various currently used techniques, liquid chromatography in the high-performance (HPLC) and ultra-performance (UPLC) versions is one of the most versatile instruments owing to its high resolution and flexibility of use, with great potential in the preparative scale-up. The combination of liquid chromatography with mass spectrometry (such as micro- and nano-LC-ESI-MSⁿ—liquid chromatography-electrospray ionization mass spectrometry) adds to the separation technique a powerful identification capacity.

As is known, while most conventional chromatographic stationary phases are made by packing the particle material inside the column, monolithic chromatographic columns, which have been the object of intense study over the last ten years (Hjerten, S.; Liao, J. L.; Zhang, R. J. Chromatogr. 1989, 473, 273-275; Tennikova, T. B.; Reusch, J. J. Chromatogr. A, 2005, 1065, 13-17; Benes, M. J.; Horak, D.; Svec, F. J. Sep. Sci. 2005, 28, 1855-1875), are composed of a continuous solid separation medium obtained by a single portion of highly porous material. They differ from the classic packed columns mainly for the fact that they have a continuous porous structure that can yield higher chromatographic properties, with particular reference to permeability. Unlike with porous particles, the monolithic material is characterised by the presence of continuous pores throughout the solid (flow-through pores) forming a network of interconnected channels.

There are currently two main types of monolithic materials for chromatographic applications: silica-based inorganic materials and organic polymeric ones. The silica-based inorganic monoliths (Tanaka, N.; Ebata, T.; Hashizume, K.; Hosoya, K.; Araki, M. J. Chromatogr. 1989, 475, 195-208) are generally prepared by means of sol-gel processes which generate continuous cross-links by the sol-gel conversion of a sol inside the column (normally of capillary size), followed by drying and ageing processes. The final result is the formation of a solid and continuous porous structure inside the column.

Organic monoliths with rigid polymeric structure are essentially based on three types of chemistry: polyacrylamides (Palm, A.; Novotny, M. V. Anal. Chem. 1997, 69, 4499), polystyrenes (Gusev, I.; Huang, X.; Horvath, C. J. Chromatogr., A 1999, 855, 273-290), and polyacrylates (Peters, E. C.; Petro, M.; Svec, F.; Frechet, J. M. J. Anal. Chem. 1997, 69, 3646). The polymeric cross-linking is formed inside the column by means of a polymerization process starting from mono- and multifunctional (usually bifunctional) polymerizable monomers in the presence of suitable “porogenic” solvents. These solvents control the formation of pores by influencing the solvation of the polymer chains in the reaction medium during the first stages of the polymerization process (Svec, F. LC-GC June 2004, 18-21).

Considering the performance of the various types of chromatographic supports, in chromatography on particle stationary phases the solutes penetrate the porous particles and pass through them by diffusion, while the convective carrier is limited to the inter-particle gap. In liquid-solid chromatographic processes, transfer between the mobile phases and stationary phase of macromolecules like proteins, nucleic acids, polysaccharides and synthetic polymers is usually very slow, while the transfer of molecules of low molecular weight is relatively fast. This is essentially due to the great difference in diffusion coefficients between large and small molecules.

The effect negatively affects the overall process when mass transfer velocity limits overall velocity, as with high-speed chromatography. An apparently simple way to make mass transfer in porous particles more efficient is to reduce their size and diffusion path. In effect, this variation has positive effects on mass transfer, but it also leads to a decrease in inter-particle gaps, with the resulting increase in the pressure necessary to make the mobile phase flow through the column.

The alternative approach, represented by a monolithic configuration of the stationary phase, allows an independent optimisation of the size of the “flow-through” channels and of the depth of the diffusive pores. This approach allows the simultaneous maximisation of mass transfer and column permeability (Svec, F.; Huber, C. G. Anal. Chem A—Pages 2006, 78(7), 2100-2107).

As a result of the foregoing, inert materials characterised by a structure of continuous porosity are used and studied for chromatographic applications, as alternative supports to particle materials. In particular, considering the field of monolithic materials for chromatographic applications of the organic type, recent studies have shown the possibility of achieving high-speed separations by means of stationary phases consisting of macroporous monolithic organic polymeric elements. Specifically, the literature describes some polymethacrylate-based organic monoliths characterised by bimodal porosity, i.e. with diffusive pores (mesopores) around 100 Å in size and convective pores (macropores) of about micron size, with total porosity from 60% to 80%. The continuous porous structure enables achieving high mobile phase flows with low pressure drops and high chromatographic efficiency due to the lower diffusive layer and to the efficient convective transport of the solutes.

Further examples of macroporous polymeric materials produced in monolithic form for applications in liquid chromatography are described in European patent EP 0609373 (Cornell Research Foundation Inc., inventors J. M. J. Frechet and F. Svec), concerning monolithic columns suitable for HPLC, contained in metal tubes and having a porosity with bimodal distribution, obtained via in-situ polymerization of appropriate mixtures of vinyl monomers in the presence of a porogenic agent.

The preparation of these monolithic supports is usually carried out by means of thermal radical polymerization or photochemical polymerization processes. In both cases, a radical initiator is introduced into the reaction mixture containing the polymerizable monomer, possibly with a cross-linking agent, and a porogenic solvent.

In particular, thermal polymerization is usually carried out by incorporating a radical initiator (such as azo-bis-isobutyrronitrile or dibenzoyl peroxide) in the reaction medium which upon heating is cleaved to yield radical fragments that act as initiators of the polymerization process. An alternative method consists of systems based on radical initiators generated by redox processes (such as peroxodisulfate and TEMED (N,N,N,N-tetramethylethylene diamine)) suitable for the preparation of monoliths in an aqueous environment.

Photochemical polymerization envisages the use of a radical photoinitiator and the irradiation of the reaction mixture with UV radiation (Rohr, T. et al. Macromolecules, 2003, 36, 1677-1684).

The aforesaid preparations of monolithic supports for chromatography by means of a radical polymerization of the thermal kind or with photoinitiators present some drawbacks, however. First and foremost of these is the fact that the residues present in the polymeric products thus obtained, due to the use of initiators, can generate materials of non-optimal properties. For example, some end groups deriving from the initiator can lead to thermal instability or, in biochromatographic systems, can lead to aspecific adsorbance processes.

Moreover, thermal polymerization takes place at a high temperature, and this rules out the use of solvents with a low boiling point, and can also lead to irregularities in the final material, due to the thermal expansion of the solvent or to its evaporation.

On the other hand, the photo-polymerization process, carried out directly inside the final vessel (chromatographic column), limits the size and nature of the material of the vessel itself (capillary, microbore column, standard analytical column, preparatory columns, made of materials such as silica, glass, steel, PEEK (polyether etherketone), PEEKsil (a PEEK covered fused silica tube), GLT-tubing (glass-lined tubing: vitrified steel)), because UV radiation cannot uniformly reach all the polymerisable material.

These drawbacks can lead to irregularities and a non-homogeneity in the final structure of the monolith, to the detriment of chromatographic performance, and result in a poor reproducibility in column properties. It is thus desirable to have an alternative method for preparing monolithic columns that is both easy to carry out and capable of generating high-efficiency columns with well-defined and easily controllable pores. Other desirable properties are the high reproducibility and flexibility of use, both as regards the various types of columns currently used (capillary, narrow-bore, standard and preparatory columns, etc.) and their constitutive materials (fused silica, steel, PEEKsil, GLT-tubing, etc.). A further aspect to consider is the possibility of producing at low temperatures and particularly of also conducting polymerization in the solid state.

An alternative method for initiating a polymerization process envisages the use of ionising radiations, i.e. radiations which, unlike UV and other visible ones, have sufficient energy to ionise the atoms they come into contact with, such as X rays and γ rays in the electromagnetic radiation range. There are several advantages in using radiation-induced polymerization processes for the production of advanced polymeric materials: the first advantage lies in the possibility of carrying out the process at room temperature or lower. This would allow the use of even solvents with low boiling points, would avoid the development of irregularities in the final material owing to the thermal expansion of the solvent, and—with a view to a scale-up at industrial level—would mean a potential energy saving.

Moreover, polymerization can be obtained without resorting to the addition of radical initiators, and thus means obtaining a final material of high chemical purity. The only residue potentially present in the final product is the non-polymerized monomer itself, along with small quantities of by-products generated by the ionising radiation.

In most of the cases described in the literature, the radiation-induced polymerization processes are initiated by γ rays. As is known, γ rays are produced by transitions taking place within the nuclei of certain radioactive elements such as the γ-emitting isotopes ⁶⁰Co, ¹³⁷Cs or ¹²⁵I. The photons emitted are monoenergy ones and specific of the isotope they come from. The radioactive isotope most widely used for γ radiation is cobalt-60, an isotope with a half-life of 5,272 years. Co-60 emits two γ photons of equal intensity of 1.17 and 1.33 MeV. The favourable properties of the irradiators containing Co-60 (such as the ones known under the name of Gammacell) are the long half-life, the high penetration power of the rays and the ease of production.

A study at experimental level of the production of macroporous polymeric monoliths to be used in applications like separation or purification via liquid chromatography, in which the macroporous polymer is obtained in monolithic form by means of γ-radiation-induced polymerization, is described by Agnes Sáfrány and co-workers (Sáfrány, A. et al. Polymer, 2005, 46, 2862-2871). In this case, monoliths of methacrylate polymers (diethylene glycol dimethacrylate) were prepared in moulds composed of Teflon tubes of 4 mm internal diameter for in-situ polymerization by using a Co-60 based γ radiation source, and experimenting various porogenic solvents (methanol, propanol, butanol, acetone, ethyl acetate, dioxane, acetonitrile and tetrahydrofuran) and various irradiation conditions, with a total absorbed dose ranging between 1 and 50 kGy, as well as at different temperatures. The various monoliths obtained were in any case removed from the Teflon tube moulds. Alternatively, stainless steel pipes (4 mm i.d.) were used and then applied—after polymerization—directly for the characterisation measurements of the monolith. In all the cases described, the aim was that of producing a monolithic plug of suitable characteristics to be used as a continuous porous medium for chromatographic separations, in which polymerization was obtained by avoiding the addition of radical initiators.

On the basis of this prior art, the present invention thus aims at providing new polymer-based monolithic high-performance chromatographic columns having the aforesaid desirable characteristics for the stationary phases of apparatuses for liquid chromatography, and that could be obtained through the polymerization of monomers directly inside the final vessels (columns) by means of gamma radiation-induced polymerisation processes. The columns should not have any particular limitations as regards their constitutive materials, the nature of the porogenic solvents and the polymerization temperature.

According to the invention, it has been found that it is possible to obtain high-efficiency monolithic columns with a preparation method based on gamma radiation-induced polymerization of a mixture of monomers and cross-linking agents, in the presence of suitable solvents, directly inside chromatographic columns whose internal walls have been appropriately pre-treated in order to activate them, functionalising them with fragments of molecules able to covalently bond the forming polymer to the said internal walls. In this way, the polymerization of the monolith that constitutes the stationary phase takes place directly inside the capillary or column which will then constitute the chromatographic apparatus, and the monolithic “plug” constitutes a single body with the column that acts as its container.

Therefore, the present invention specifically provides a chromatographic column for high-performance liquid chromatography comprising a hollow tubular support consisting of amorphous material based on silica or internally lined with such a material, containing a monolithic stationary phase having a continuous polymeric porous and rigid structure, characterised by the fact that such stationary phase is covalently bonded to the internal walls of the said hollow tubular support and by the fact that the chromatographic efficiency of the column is greater than 50,000 plates per metre, and preferably greater than 60,000 plates per metre. Moreover, as another characterising element, the variation in retention times after prolonged use of the chromatographic column according to the invention is lower than 5%.

The hollow tubular support of the proposed column can be composed of any amorphous silica-based material which enables pre-treatment of its internal walls in order to covalently bond the polymer to the said internal walls, and may, in particular, be made of fused silica, vitrified steel or GLT-tubing, or PEEKsil or fused silica coated with polyether etherketone, with a possible external layer of polyimide. Preferably, the hollow tubular support of the invention is made of fused silica.

The internal diameter of the said hollow tubular support can be suitable for use in capillary columns, i.e. ranging between 100 and 500 μm, or may have other sizes (nanobore: 25-100 μm i.d.; microbore 1.0-2.1 mm i.d.; standard bore 4.0-5.0 mm i.d.). In general, the hollow tubular support according to the present invention has an internal diameter from 25 μm to 5 mm and, according to specific solutions, ranging between 100 and 500 μm (capillaries), and between 2 and 5 mm (standard columns).

The length of the hollow tubular support of the chromatographic column according to the present invention usually ranges between 10 and 100 cm.

According to what is proposed by the present invention, the monolithic stationary phase is covalently bonded to the internal walls of the hollow tubular support by pre-treatment with a silane containing methacryloyl functions (the “grafting to the wall” process), or, according to a different procedure, the monolithic stationary phase is covalently bonded to the internal walls of the hollow tubular support by an activation pre-treatment by introducing azo groups bonded to the said internal walls (grafting from the wall). The “grafting from the wall” approach enables introducing azo fragments onto the internal walls of the tubular support. These fragments are able to generate radical species triggering the polymerization process from the wall of the tubular support inwards, creating an “active” functionalising of the internal surfaces of the tubular support.

According to a further aspect thereof, the present invention also concerns a process for preparing a column for high-performance liquid chromatography, comprising a hollow tubular support and a monolithic stationary phase having a continuous, porous and rigid polymeric structure covalently bonded to the internal walls of the said hollow tubular support, the said process consisting of the following steps:

a) preparing a hollow tubular support made of amorphous silica-based material or internally lined with such material, with pre-treatment of the internal walls by etching followed by a treatment with a silane containing methacryloyl functions or by introducing azo groups covalently bonded to the said internal walls;

b) adding a degassed mixture of monomers and cross-linking agents and porogenic agents to the said tubular support;

c) polymerizing the said mixture by irradiating with gamma rays;

d) washing the column after polymerization in order to remove the non-polymerized monomers and solvents.

The monomers used according to the present invention are organic compounds of low molecular weight, containing functional groups that can react within a gamma radiation-induced polymerization process, and one or more functions able to interact with the solutes during a chromatographic process (alkyl chains for water-resistant interactions in reversed-phase chromatography, polar groups for normal phase chromatography, ionisable or ionised groups for ionic exchange interactions in ionic chromatography). In general, the monomer compound may be a derivative of acrylic or methacrylic acid with alcohols or diols, amines or diamines. The bifunctional monomer (derivatives of diols or diamines) acts as a cross-linking agent. Alternatively, the monomer and cross-linking agent can be represented by derivatives of styrene and divinylbenzene.

According to some specific embodiments of the present invention, the degassed mixture of monomers and cross-linking agents includes one of the following pairs of compounds: acrylate and diacrylate monomers, methacrylate and di-methacrylate monomers, methacrylate and tri-methacrylate monomers, methacrylate and tetramethacrylate monomers, acrylate monomers and polyethylene glycol diacrylate, methacrylate monomers and polyethylene glycol dimethacrylate, styrene monomers and divinylbenzene, acrylamide monomers and N,N′-methylene bis-acrylamides.

In particular, the mixture of monomers and cross-linking agents can include methacrylate monomers of the following formula:

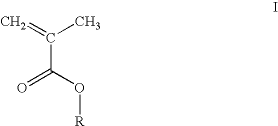

wherein R is a linear alkyl group possibly substituted, a phenyl, biphenyl, benzyl or aryl-C₁-C₁₀ alkyl group, possibly substituted, a perfluorinated alkyl group, or a molecular radical containing functional groups chosen from epoxy, cyano, carboxy, sulfonic, dialkylamine, trialkylammonium groups, and di- or polyfunctional monomers.

According to other specific solutions, the mixture of monomers and cross-linking agents includes styrene monomers having the following formulas:

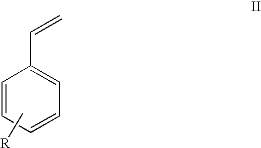

wherein R is a linear alkyl group possibly substituted, a phenyl, biphenyl, benzyl or aryl-C₁-C₁₀ alkyl group, possibly substituted, a perfluorinated alkyl group, or a molecular radical containing functional groups chosen from epoxy, cyano, carboxy, sulfonic, dialkylamine, trialkylammonium groups, and divinylbenzene.

The pre-treatment of the internal surfaces of the tubular support of the chromatographic columns according to the present invention that uses a silane containing methacryloyl functions and preferably achieved by filling the said hollow tubular support with a solution of 3-(trimethoxysilyl)propylmethacrylate in toluene containing 2,2′-diphenyl-1-picrylhydrazyl radical (DPPH), and preferably by heating at 110° C. for 6 hours.

In the case that the pre-treatment of active functionalisation according to the present invention is carried out, the said introduction of azo groups covalently bonded to the internal walls of the tubular support is performed by filling the said support with a first solution of 3-aminopropyltriethoxysilane in anhydrous toluene, heating, washing and drying, and then filling with two solutions in equal proportions, having the following composition:

A) 1-methoxy-2-methyl-1-(trimethylsiloxy)propane in anhydrous toluene;
B) 4,4′-azobis-4-cyanovaleric acid chloride in anhydrous THF,
washing and drying. During the treatment with the said first solution, the mixture is heated preferably at 90° C. for 3 hours, and according to a specific executive form of the invention, the solutions A) and B) are in equal proportions and are maintained in the said tubular support at room temperature for 50 minutes.

The organic monolithic materials constituting the stationary phase of the chromatographic columns according to the present invention were prepared and characterised by scanning electron microscopy (SEM), infrared spectroscopy FT-IR (DRIFT, ATR, transmittance), FT-Raman, ¹³C CP-MAS NMR, thermogravimetric analysis (TGA), differential scanning calorimetry (DSC), mercury porosimetry and BET.

The capillary columns (with internal diameter between 50 and 500 μm and up to 100 cm in length) were characterised by means of chromatographic tests (nano- micro-HPLC, flow-curve analysis, ISEC, mechanical resistance to liquid flows (up to 40 MPa), measures of permeability) and swelling tests.

As will be more evident below, the nano-, capillary and standard analytical columns produced according to the present invention have the following advantages:
ease of preparation in highly reproducible conditions;
chemical, mechanical and thermal stability, which makes them suitable for use with organic and aqueous solvents and supercritical fluids, containing acid and base modifiers (HCOOH, CH₃COOH, CF₃COOH, Et₃N) and at extreme temperatures (from −80° C. to +100° C.);
high chromatographic efficiency and high permeability due to the continuous porous structure with a reduced diffusive layer, which make the chromatographic material suitable for analysing molecules of small and medium molecular weight, as well as biological macromolecules in high linear velocity conditions of the eluent;
a wide range of application

The specific characteristics of the present invention, as well as its advantages and relative operative modalities, will be more evident with reference to a detailed description presented merely for exemplificative purposes below, along with the results of the experimentations carried out on it and the data for comparison with the prior art. Some experimental results are also illustrated in the attached drawings, wherein:

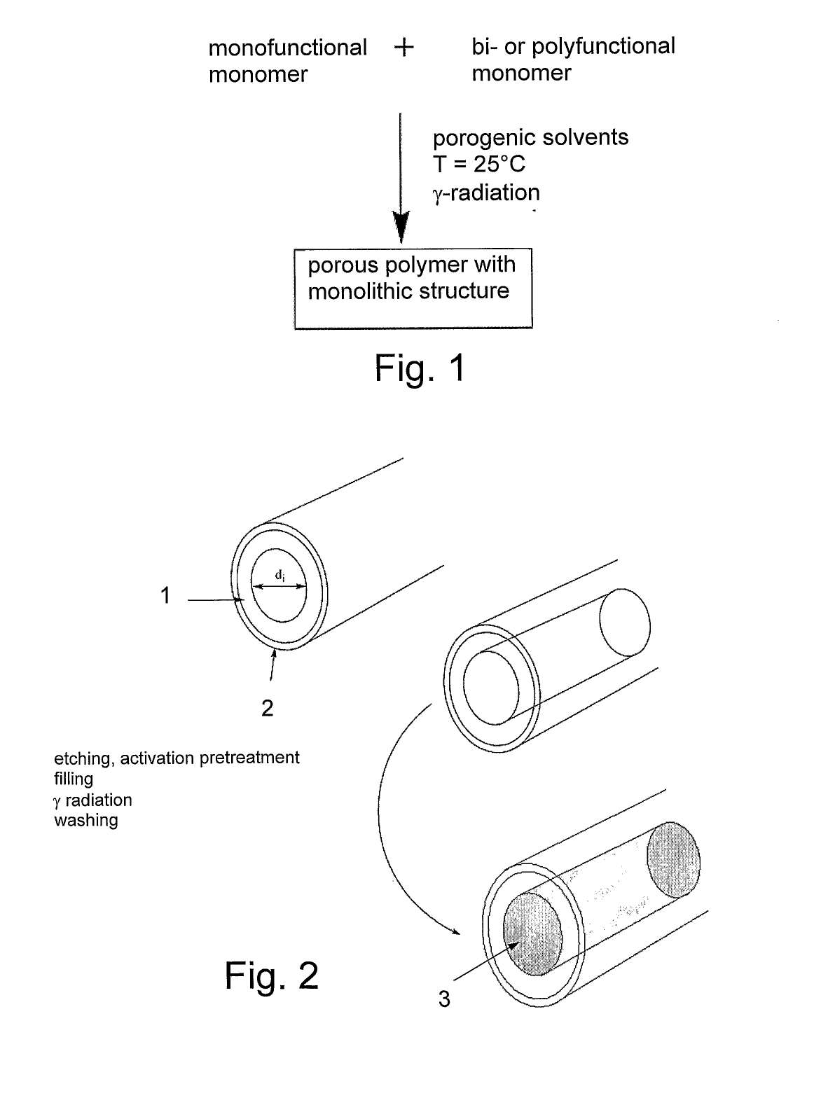

FIG. 1 illustrates the process for preparing the monolithic materials according to the present invention by gamma radiation-induced polymerization;

FIG. 2 schematically shows the process for preparing a fused-silica capillary chromatographic column according to the present invention, containing the same monolithic materials;

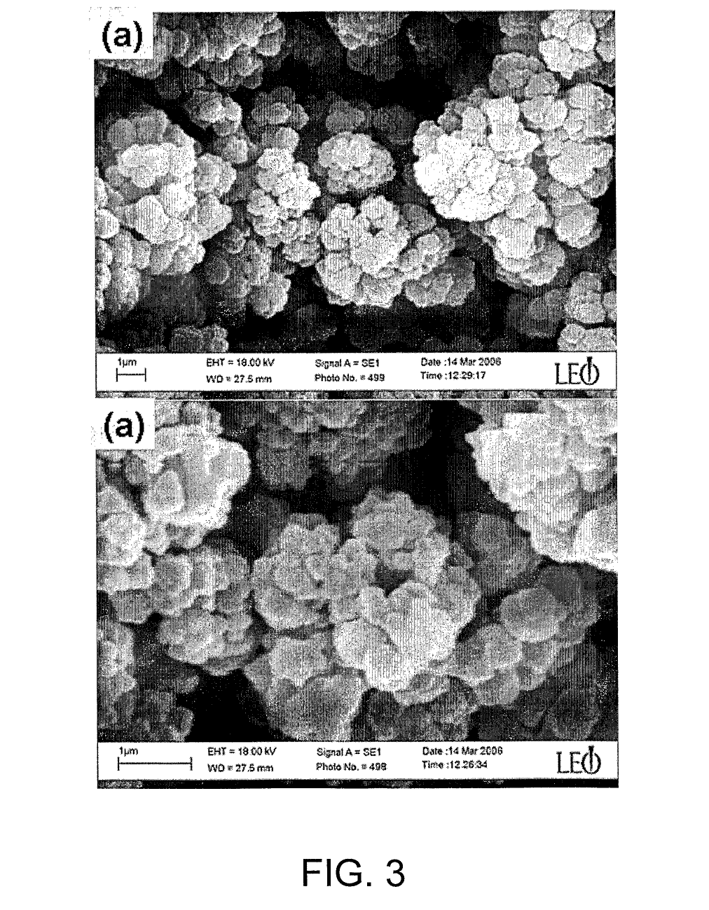

FIG. 3 shows some scanning electron microscope (SEM) images, in two different enlargements, of the monolithic material (a) prepared according to the procedure schematised in FIGS. 1 and 2, on the basis of the procedure illustrated in the realisation examples;

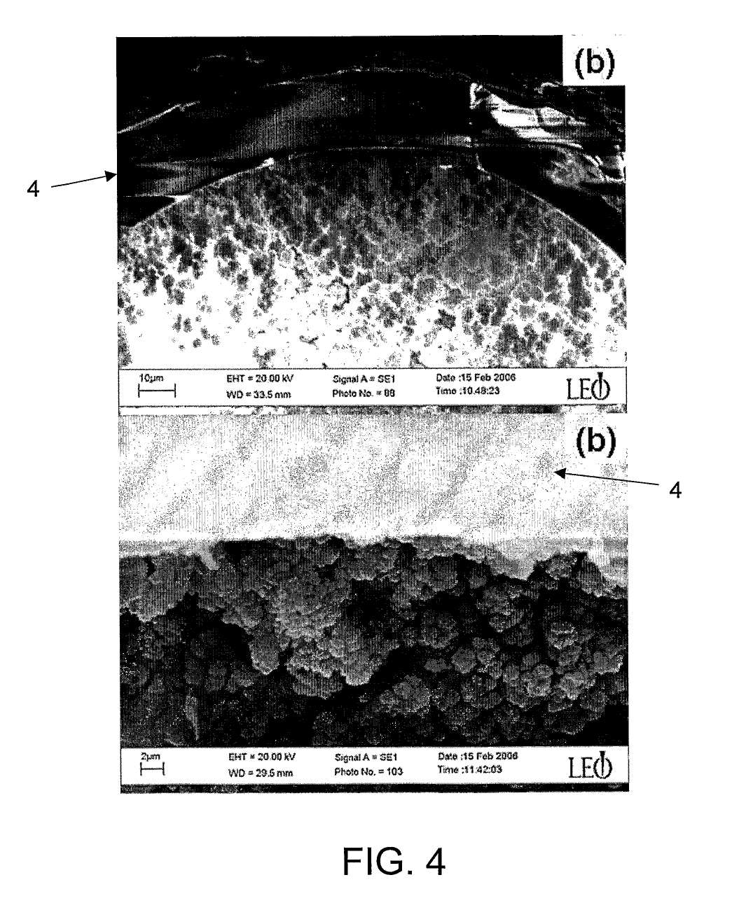

FIG. 4 shows some scanning electron microscope (SEM) images, in two different enlargements, of the capillary column (b) prepared according to the procedure schematised in FIGS. 1 and 2, on the basis of the procedure illustrated in the realisation examples;

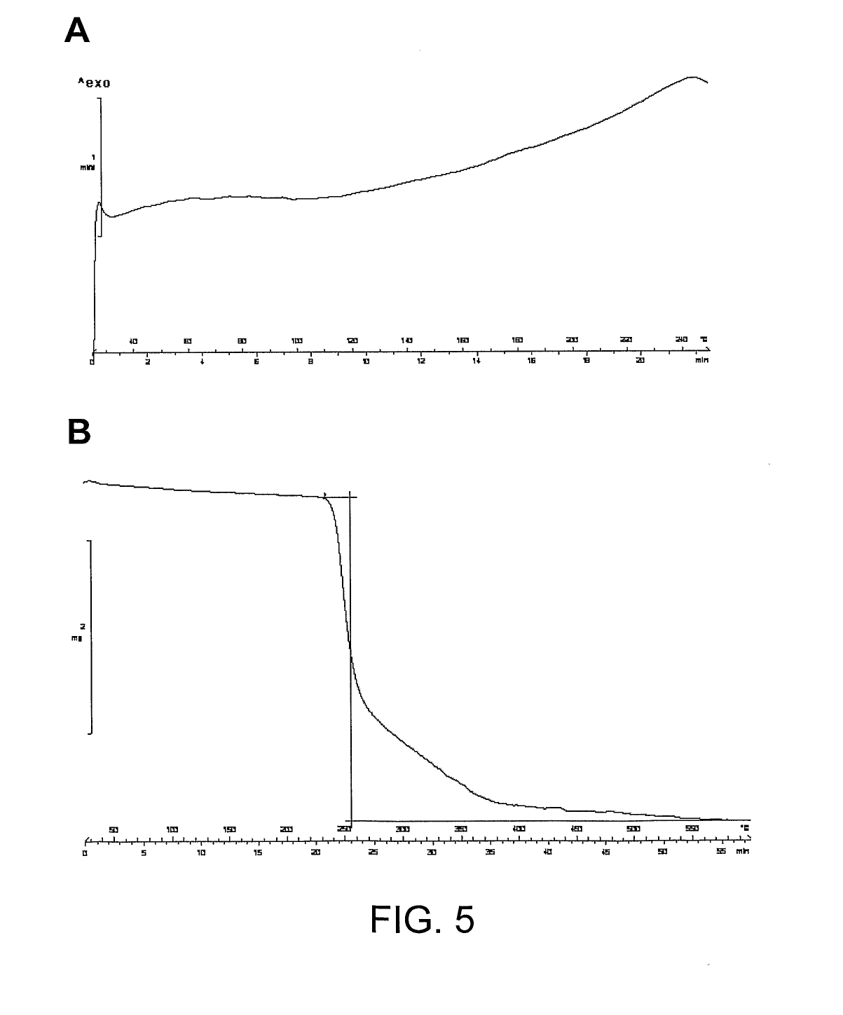

FIG. 5 illustrates the DSC (A) and TGA (B) analyses carried out on a monolith sample prepared according to the realisation examples.

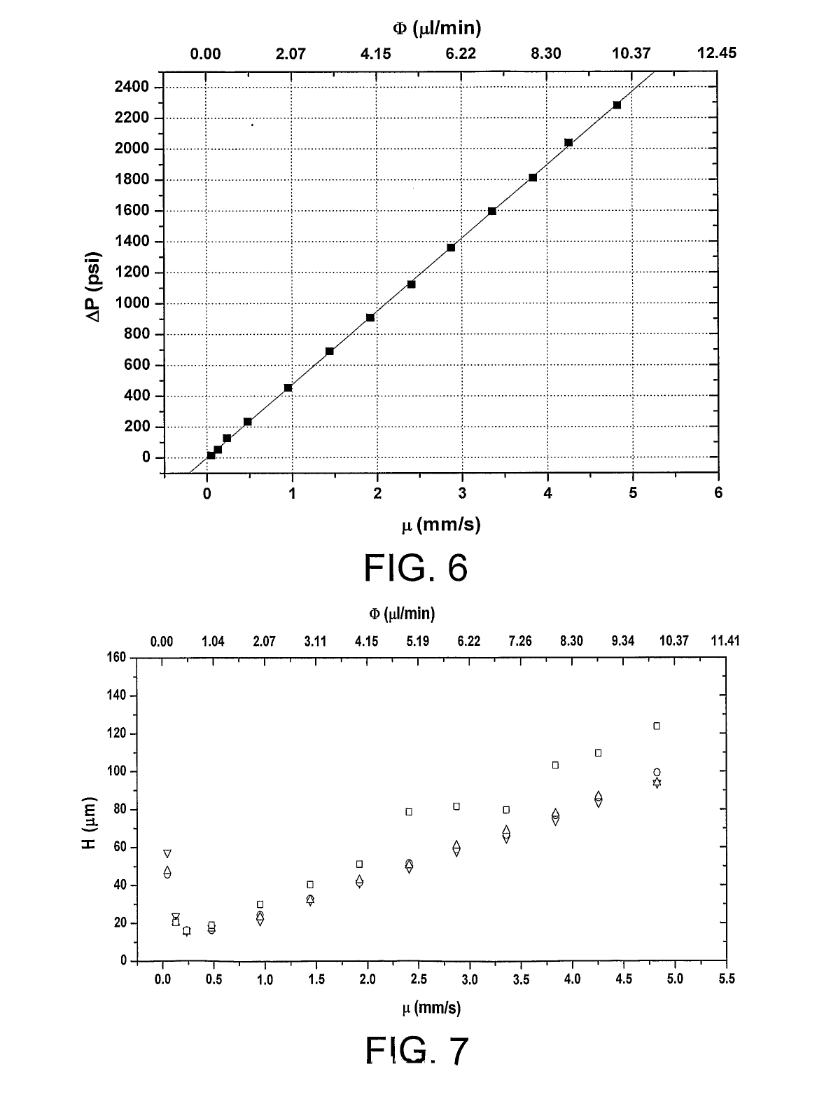

FIG. 6 illustrates the linear dependence of the operating pressure value as a function of the linear velocity of the eluent, for a capillary column prepared according to the realisation examples; column 250*0.25 mm; eluent: ACN/H₂O 60/40; permeability: K₀/m²=5.58;

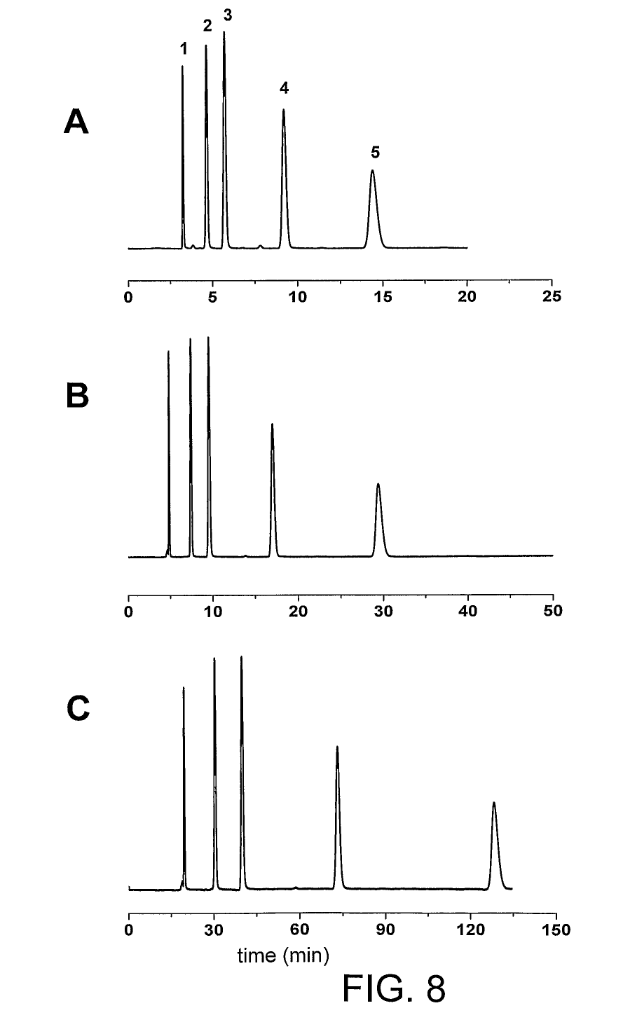

FIG. 7 shows a Van Deemter plot for a column prepared according to the realisation examples; column 250*0.25 mm; eluent: ACN/H₂O 60/40; T=25° C.; solutes: ∇ benzaldehyde, ◯ nitrobenzene, Δ ethylbenzene, □ butylbenzene;

FIG. 8 shows some chromatograms of the chromatographic separations of a mixture of aromatic solutes obtained by using different linear velocities of the eluent, on a capillary column prepared according to the realisation examples; chromatogram A: flow 3.0 μl/min, linear velocity 1.44 mm/s, solutes from 1 to 5, (k′; N/m): uracyl (k′=0), benzaldehyde (0.43; 31316), nitrobenzene (0.76; 30444), ethylbenzene (1.83; 31084), butylbenzene (3.44; 24812); chromatogram B: flow 2.0 μl/min, linear velocity 0.952 mm/s, solutes from 1 to 5, (N/m): uracyl, benzaldehyde (46504), nitrobenzene (40980), ethylbenzene (42876), butylbenzene (33388); chromatogram C: flow 0.5 μl/min, linear velocity 0.235 mm/s, solutes from 1 a 5, (N/m): uracyl, benzaldehyde (63772), nitrobenzene (62820), ethylbenzene (65235), butylbenzene (62692); column 250*0.25 mm; eluent: ACN/H₂O 60/40; T=25° C.; pneumatic injector, injection volume 60 nl; UV detection at 214 nm, AUFS: 0.05;

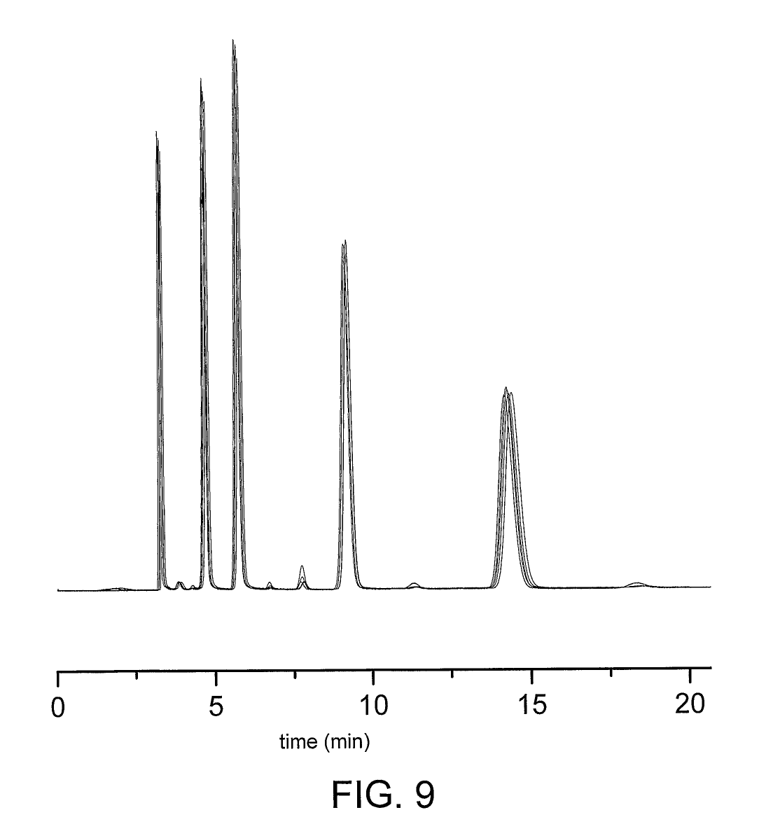

FIG. 9 illustrates the reproducibility of the chromatographic parameters for 5 consecutive replicated tests; column: 250*0.25 mm; eluent: A: H₂O/ACN 95/5; B:ACN: NB 42/58; flow: 3 μl/min; pneumatic injector, injection volume 60 nl; UV detection at 214 nm, AUFS: 0.05;

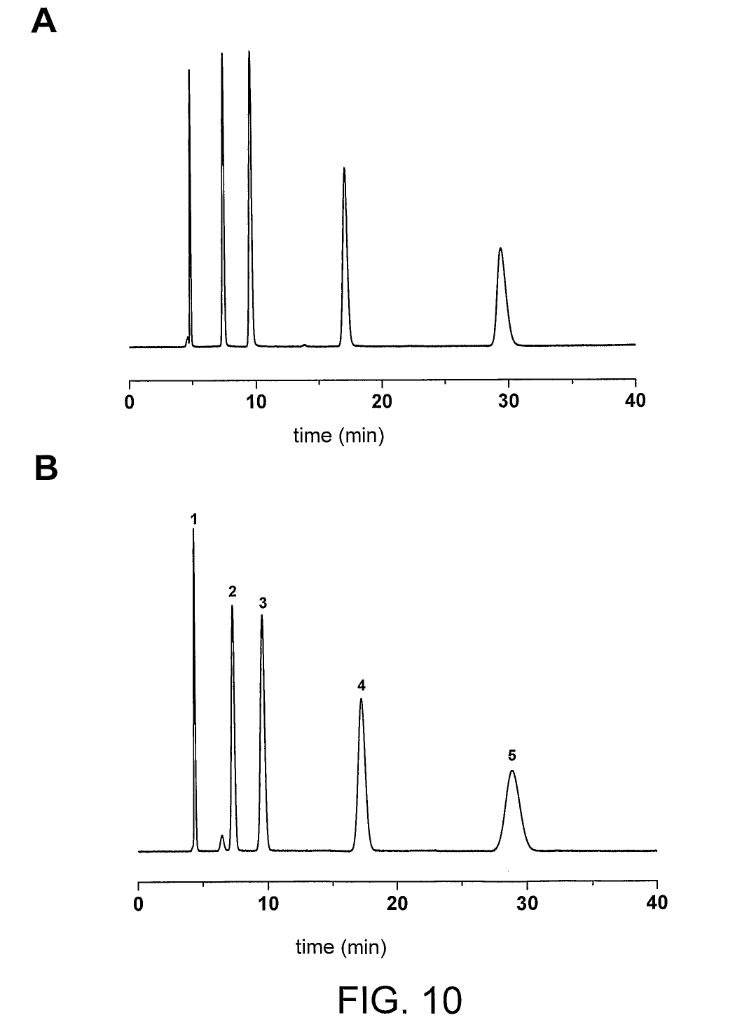

FIG. 10 shows two chromatograms of the chromatographic separations of a mixture of aromatic solutes, obtained on two monolithic capillary columns prepared according to the realisation examples and that differ only for their internal diameter (length: 25 cm; diameters: 0.250 (A) and 0.320 mm (B)); eluent: ACN/H₂O 60/40; T=25° C.; pneumatic injector, injection volume 60 nl; UV detection at 214 nm, AUFS: 0.05; solutes 1-5: uracyl, benzaldehyde, nitrobenzene, ethylbenzene, butylbenzene; A: flow 2.0 μl/min, ΔP=691 psi, linear velocity 0.952 mm/s; B: flow 3.15 μl/min, ΔP=470 psi, linear velocity 1.001 mm/s;

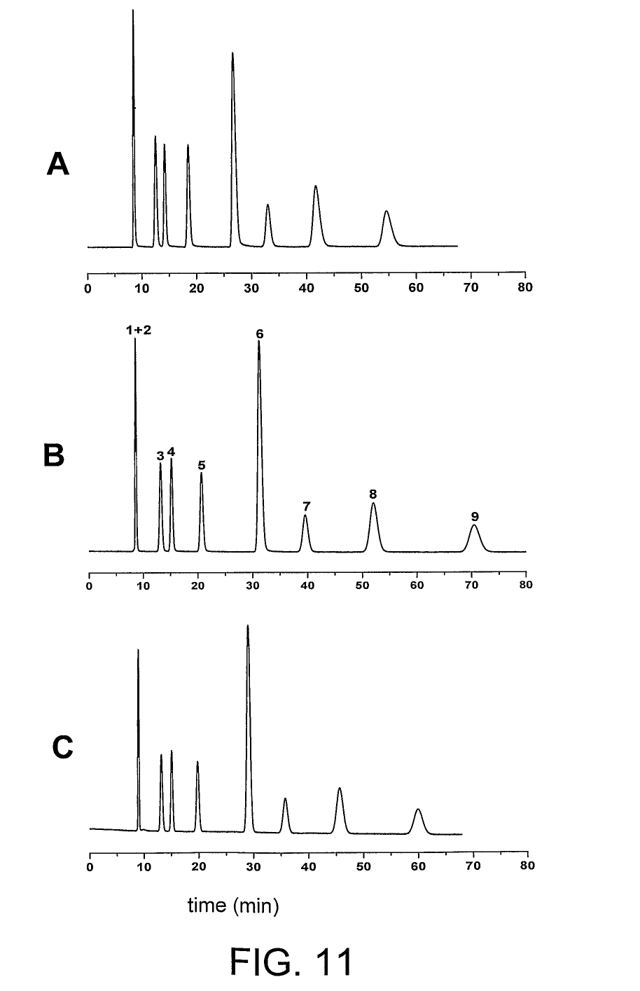

FIG. 11 shows three two chromatograms of the chromatographic separations of a mixture of aromatic solutes, obtained on three monolithic capillary columns prepared according to the realisation examples and that differ only for their internal diameter (length: 50 cm; diameters: 0.100 (A), 0.250 (B) and 0.320 mm (C)); eluent: ACN/H₂O 60/40; T=25° C.; pneumatic injector, injection volume 60 nl; UV detection at 214 nm, AUFS: 0.05; solutes 1-9: uracyl, thiourea, phenol, benzaldehyde, nitrobenzene, toluene, ethylbenzene, propylbenzene, butylbenzene; A: flow 0.250 μl/min, ΔP=900 psi, linear velocity 1.005 mm/s; B: flow 1.850 μl/min, ΔP=880 psi, linear velocity 1.001 mm/s; C: flow 3.000 μl/min, ΔP=755 psi, linear velocity 0.941 mm/s;

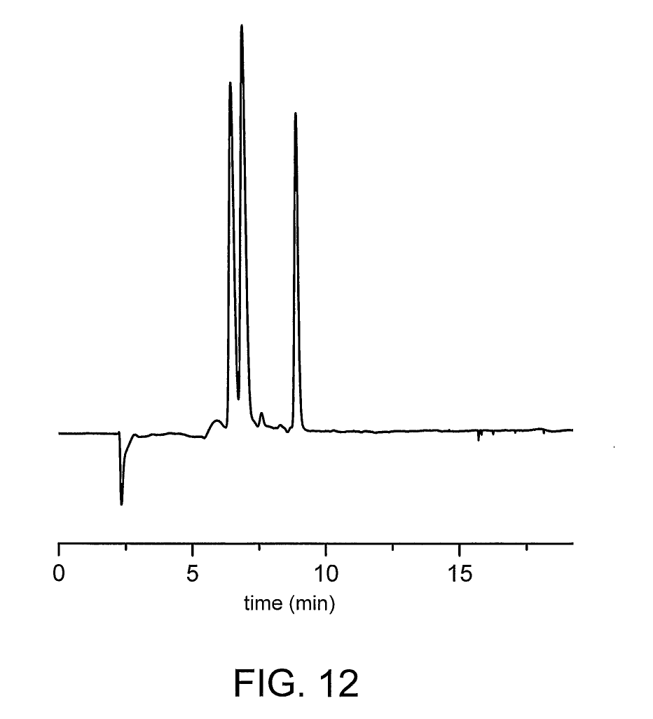

FIG. 12 shows the chromatographic separation of a mixture of peptides by means of a capillary column prepared according to the realisation examples; column: 250*0.32; eluent A: H₂O+0.05% TFA; eluent B: ACN/H₂O 80/20+0.04% TFA, gradient from 100% A (hold 1 min) to 50% A in 15 min; flow 7.00 μl/min; T=50° C.; UV detection at 214 nm; solutes: mixture of angiotensins I, II and III; and

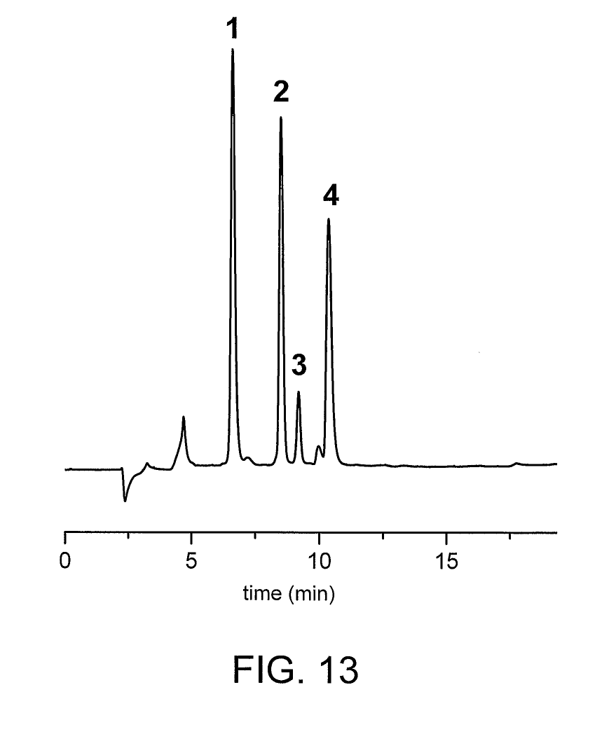

FIG. 13 shows the chromatographic separation of a mixture of proteins by means of a capillary column prepared according to the realisation examples; column: 250*0.32; eluent A: H₂O+0.05% TFA; eluent B: ACN/H₂O 80/20+0.04% TFA, gradient from 95% A (hold 1 min) to 80% A in 0.01 min, hold 1 min, to 20% A in 15 min; flow 7.00 μl/min; T=50° C.; UV detection at 214 nm; solutes 1-4: ribonuclease, cytochrome C, lysozyme, bovine serum albumin.

### EXAMPLE

According to an example of realisation of the present invention, the polymerization process inside the capillary column makes use of butylmethacrylate and ethylene glycol methacrylate as monomers, in the presence of 1-propanol, 1,4-butanediol and water as porogenic solvents, according to the scheme illustrated below. The irradiation dose is of 20 kGy, at room temperature.

The resulting polymer (A) is a methacrylic cross-linked polymer with the following formula:

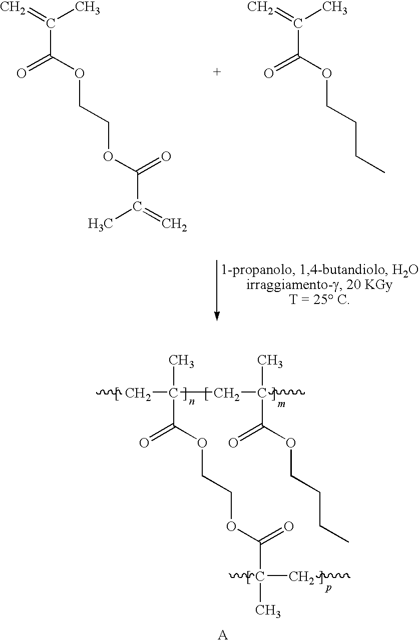

Preparation of the Monolithic Columns

The preparatory scheme of the monolithic material and of the chromatographic columns according to the present invention is FIGS. 1 and 2. The latter has arrows referring to the capillary wall (1), the internal diameter dᵢ, and the external lining (2) of the said wall, composed of a polyamide layer. The porous monolith (3) is formed inside the capillary (1) after applying the proposed process whose phases are listed in FIG. 2.

a) Pre-treatment of the capillary

a1) Etching

Procedure a1.1)

The procedure described may only be used on fused-silica columns of a wall thickness greater than 130 μm because the treatment makes the walls fragile. It is used in order to prepare capillary columns with internal walls of a high surface area. A fused-silica capillary column (300×0.100 mm) is syringe filled with a saturated solution of (NH₄)HF₂ in methanol and left for 1 h at 25° C. The capillary is then washed with 5 ml portions of methanol, 50/50 methanol/water, water, methanol and washed in a nitrogen flow (T: 25° C., P: 20 psi, 1 h).

Procedure a1.2)

This “soft” procedure is the only one usable on fused-silica capillaries of any wall thickness. The capillary is treated with an aqueous solution of 1 N sodium hydroxide for 2 h in the temperature range 40-90° C., and then washed with bi-distilled H₂O until neutrality, treated with an aqueous solution of 0.1 N hydrochloric acid for 1 h at room temperature and finally washed with consecutive 5 ml portions of water and methanol.

a2) Silanization

Procedure a2. 1) (“Grafting to the Wall”)

(activation via methacrylate) Using a syringe, the capillary is filled with a solution of 50/50 3-(trimethoxysilyl)propyl-methacrylate/toluene v/v containing 0.005% p/v of 2,2′-diphenyl-1-picryl-hydrazyl radical (DPPH). The capillary is heated at 110° C. for 6 h and, after cooling, washed with consecutive 5 ml portions of toluene and methanol, and finally dried in nitrogen.

Procedure a2. 2) (“Grafting from the Wall”)

(activation via azo) Using a syringe, the capillary is filled with a solution of 3-aminopropyl-trietoxy-silane in anhydrous toluene (10% v/v), heated at 90° C. for 3 h and, after cooling, washed with 5 ml of toluene and dried in nitrogen.

Two solutions are then prepared:

A: 1-methoxy-2-methyl-1-(trimethylsiloxy)propene in anhydrous toluene (20% v/v);

B: 4,4′-azo-bis-4-cyanovaleric acid chloride in anhydrous THF (3.33% w/v).

The capillary is filled by syringe with a solution prepared by mixing equal parts of solutions A and B, maintained for 50 minutes at a temperature of 25° C., and finally washed with toluene and dried in nitrogen.

b) Preparation of a Polymerization Solution Containing a Monomer, Cross-Linking Agent and Porogenic Solvents

The monomers butyl methacrylate (0.586 ml, d=0.895 g/ml, equal to 60.1% percentage weight of the total monomers) and ethylene glycol dimethacrylate (0.389 ml, d=1.051 g/ml, equal to 39.9% percentage weight of the total monomers) were dissolved in the porogenic solvents 1-propanol (1.210 ml, d=0.804 g/ml, equal to 53.2% percentage weight of the total porogens), 1,4-butandiol (0.837 ml, d=1.014 g/ml, equal to 36.8% percentage weight of the total porogens) and H₂O (0.227 ml, d=1.000 g/ml, equal to 10% percentage weight of the total porogens). The monomer/porogen weight ratio is equal to 31.2/68.8.

c) Filling the Capillary with the Polymerization Solution

The polymerization solution is degassed by means of helium sparging for 5 minutes at room temperature. Through a slight argon pressure, it is then introduced into the capillary in an inert atmosphere. The ends of the capillary column are finally sealed by a siliconated rubber body.

d) Gamma Radiation-Induced Polymerization

The capillaries filled with the polymerization solutions are placed inside a Gammacell and irradiated at a temperature of 25° C. with doses of 20, 30 or 40 kGy, at an administration rate of about 2 kGy/h.

e) Washing the Capillaries Containing the Porous Monolithic Polymer

The capillaries are connected to an apparatus for micro-HPLC and washed with acetone (about 50 column dead volumes) under constant pressure (10 MPa).

Chemical-Physical Characterisation of the Monoliths and Chromatographic Characterisation of the Capillaries Containing the Monoliths

Chemical-Physical Characterisation of the Monoliths

The chemical-physical characterisation of the monolithic polymeric material was carried out on monoliths obtained in closed cylindrical steel containers 50×4.0 mm in size. The polymeric material, obtained after gamma irradiation in them with conditions described in the previous example for polymerization inside capillaries, is washed with consecutive 10 mL portions of acetone, methanol and acetone, and then dried under reduced pressure (0.1 mm Hg) at 140° C. for 12 h.

Scanning electron microscopy Portions of the monolith of about 2 mm² were attached to the sample-holders using biadhesive tape and covered by sputtering with a thin layer of gold. Similar treatment was performed on portions of the capillary containing the monolith, after washing with acetone and drying in nitrogen. The SEM analyses were carried out on the monolithic material by recording images at enlargement of 500, 5000 and 10000 times. The SEM analyses were carried out on the capillary containing the monolithic material by recording images at enlargements of 500, 5000 and 10000 times.

As shown in FIG. 3, the polymeric materials appear uniform at low enlargements and show a continuous porous structure at high enlargements, with homogenous pore structure and dimensions for the material under observation. Pore dimensions range from 0.5 to 2-3 μm. Analysis of the capillaries containing the monolith, as shown in FIG. 4, reveals that the latter well-adheres to the walls of the capillary (4) itself. No significant discontinuities are found on the internal walls of the capillary (4), thus confirming the stable bond between the polymeric material and the functionalised walls of the capillary itself. Different sections of the capillary, along its length, do not show any appreciable differences in the structure of the monolith or in its capacity to stick to the capillary walls.

Vibrational spectroscopy—FT-IR spectra were recorded on the monolithic material in DRIFT mode (diffuse reflectance), ATR (attenuated total reflectance) and transmittance. In all cases, the spectrum is dominated by bands due to stretching of the ester carbonyl and stretching of the C—O single bond, at 1720-1730 and 1130-1140 cm⁻¹, respectively. The band due to stretching of the C═C double bond of the starting methacrylate (1640 cm⁻¹) is visible, but has a very decreased intensity thereby indicating the almost complete conversion of the olefinic bonds in the radiation-induced polymerization process.

Even the Raman spectrum, recorded in ATR mode, clearly shows the characteristic bands of the ester fragment and some absorptions of lower intensity due to residual olefinic double bonds.

Solid state nuclear magnetic resonance spectroscopy (¹³C CP MAS NMR)—All the signals envisaged on the basis of the structures of the monomer and cross-linking agent are observed. There are clear signs due to the ester carbonyl (176 ppm), the carbons of the alcoholic portion (63, 30, 18 and 13 ppm), and to the carbons of the polymeric skeleton (44 and 54 ppm).

The signals due to the olefinic carbons of the starting monomers (between 125 and 135 ppm) are absent.

Thermal gravimetric analysis (TGA) and differential screening calorimetry (DSC)—As shown in FIG. 5, TGA carried out in the temperature range 25-600° C. shows a stability to heat up to 220° C. Weight loss is observed up to a temperature of 400° C., with complete pyrolysis and volatilisation between 400 and 600° C.

Chromatographic Characterization of the Capillary Columns Containing Monolithic Materials

Capillary columns of 250 μm diameter and 25 cm length were used for chromatographic characterisation. After washing with acetone and methanol, the monolithic columns are balanced with the mobile phase at room temperature. Chromatographic efficiency was evaluated by variable flow analysis of a mixture of standard solutes. The mechanical stability of the monolith inside the capillary was evaluated by recording the operating pressure values as a function of the eluent flow (Pₘₐₓ 30-40 MPa).

FIG. 6 shows a strictly linear variation between linear velocity of the eluent and operating pressure, in the velocity range between 0.05 and 3.05 mm/s, indicating a complete absence of phenomena of compression of the chromatographic bed in response to pressure stress.

The data on chromatographic efficiency (FIG. 7) indicate that the capillary columns prepared according to the present invention have chromatographic efficiencies between 50,000 and 60,000 plates per metre, with a linear velocity of the eluent in the region of the minimum of the efficiency curve (linear velocity ranging between 0.500 to 1.00 mm per second). The asymmetry of the chromatographic peaks is also very low, usually lower than 1.10.

Applications

Applicative examples—The following examples are presented to illustrate the advantages of the present invention and are not in any way meant to limit the scope thereof.

In a series of practical applications, the capillary column produced according to the examples was employed in the separation of some mixtures of aromatic solutes, peptides and proteins with elution in gradient and UV detection. As illustrated in FIGS. 8-13, it is possible to obtain complete separations in a short time, with a considerable symmetry of chromatographic peaks.

At present, by radiation-induced polymerization processes inside capillaries, it is possible to produce high-efficiency microcolumns for applications in nano- and micro-HPLC and LC-MS. Potential fields of application are the analysis of molecules of low molecular weight (pharmaceuticals, peptides, pesticides, agrochemicals, food additives) and biomolecules (proteins, oligonucleotides, RNA fragments, DNA, polysaccharides).

The present invention has been disclosed with particular reference to some specific embodiments thereof, but it should be understood that modifications and changes may be made by the persons skilled in the art without departing from the scope of the invention as defined in the appended claims.

1. A chromatographic column for high-performance liquid chromatography comprising of a hollow tubular support made of amorphous material based on silica or internally lined with such material, containing a monolithic stationary phase having a continuous polymeric porous and rigid structure, characterised by the fact that such stationary phase is prepared by in situ polymerization of a mixture of monomers, cross-linking agents and porogenic agents by irradiation with gamma rays and covalently bonded to the internal walls of the hollow tubular support through pre-treatment with a silane containing methacryloyl functions or through an activation pre-treatment by introducing azo groups bonded onto the internal walls and by the fact that the chromatographic efficiency of the column is greater than 50,000 plates per meter.

2. A chromatographic column according to claim 1, wherein the chromatographic efficiency of the column is greater than 60,000 plates per meter.

3. A chromatographic column according to claim 1, wherein the hollow tubular support is made of fused silica, vitrified steel or GLT-tubing, or PEEKsil or fused silica lined with polyether etherketone.

4. A chromatographic column according to claim 3, wherein the hollow tubular support is made of fused silica.

5. A chromatographic column according to claim 1, wherein the internal diameter of the hollow tubular support ranges from 25 μm to 5 mm.

6. A chromatographic column according to claim 5, wherein the internal diameter of the hollow tubular support ranges from 100 μm to 500 μm.

7. A chromatographic column according to claim 5, wherein the internal diameter of the hollow tubular support ranges from 2 mm to 5 mm.

8. A chromatographic column according to claim 1, wherein the length of the hollow tubular support ranges from 10 to 100 cm.

9. A process for the preparation of a column for high-performance liquid chromatography consisting of a hollow tubular support and a monolithic stationary phase having a continuous, porous and rigid polymeric structure covalently bonded onto the internal walls of the hollow tubular support, the process consisting of the following steps:
a) preparing a hollow tubular support made of silica-based amorphous material or internally lined with such material, with pre-treatment of the internal walls by means of etching followed by treatment with a silane containing methacryloyl functions or by the introduction of azo groups covalently bonded onto the internal walls;
b) adding a degassed mixture of monomers, cross-linking agents and porogenic agents to the tubular support;
c) polymerizing the mixture by irradiation with gamma rays;
d) washing the column after polymerization in order to remove the non-polymerized monomers and solvents.

10. A process according to claim 9, wherein the degassed mixture of monomers and cross-linking agents includes one pair of compounds selected from the group consisting of: acrylate and diacrylate monomers, methacrylate and dimethacrylate monomers, methacrylate and tri-methacrylate monomers, methacrylate and tetramethacrylate monomers, acrylate monomers and polyethylene glycol diacrylate, methacrylate monomers and polyethylene glycol dimethacrylate, styrene monomers and divinylbenzene, acrylamide monomers and N₁N-methylene bis-acrylamides.

11. A process according to claim 9, wherein the degassed mixture of monomers and cross-linking agents includes methacrylate monomers having the following formula: 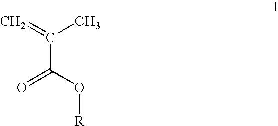
wherein R is a linear alkyl group, substituted or unsubstituted, a phenyl, biphenyl, benzyl or aryl-C₁-C₁₀ alkyl group, substituted or unsubstituted, a perfluorinated alkyl group, or a molecular radical containing functional groups selected from the group consisting of epoxy, cyano, carboxy, sulfonic, dialkylamine, trialkylammonium groups, and di- or polyfunctional monomers.

12. A process according to claim 9, wherein the degassed mixture of monomers and cross-linking agents includes styrene monomers having the following formula: 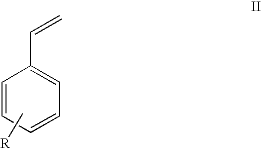
wherein R is a linear alkyl group, substituted or unsubstituted, a phenyl, biphenyl, benzyl or aryl-C₁-C₁₀ alkyl group, substituted or unsubstituted, a perfluorinated alkyl group, or a molecular radical containing functional groups selected from the group consisting of epoxy, cyano, carboxy, sulfonic, dialkylamine, trialkylammonium groups, and divinylbenzene.

13. A process according to claim 10, wherein the treatment with a silane containing methacryloyl functions is carried out by filling the hollow tubular support with a solution of 3-(trimethoxysilyl)propyl-methacrylate in toluene containing 2,2′-diphenyl-1-picryl-hydrazyl radical (DPPH).

14. A process according to claim 13, wherein during the treatment the reaction is heated at 100° C. for 6 hours.

15. A process according to claim 10, wherein the introduction of azo groups covalently bonded onto the internal walls is carried out by filling the hollow tubular support with a first solution of 3-aminopropyl triethoxysilane in anhydrous toluene, heating, washing and drying, and subsequently filling with two solutions in equal proportions having the following composition:
A) 1-methoxy-2-methyl-1-(trimethylsiloxy)propene in anhydrous toluene;
B) 4,4′-azobis-4-cyanovaleric acid chloride in anhydrous THF, washing and drying.

16. A process according to claim 15, wherein during the treatment with the first solution the reaction is heated at 90° C. for 3 hours.

17. A process according to claim 15, wherein the solutions A) and B) are in equal parts and are maintained in the tubular support at room temperature for 50 minutes.
